(19) United States
(12) Patent Application Publication
(10) Pub. No.: US 2017/0371894 A1
(43) Pub. Date: Dec. 28, 2017

(54) SAMBA CONFIGURATION MANAGEMENT METHOD AND SYSTEM FOR NETWORK DEVICE

(71) Applicant: Phicomm (Shanghai) Co., Ltd., Shanghai (CN)

(72) Inventor: Jiajian LV, Shanghai (CN)

(21) Appl. No.: 15/538,674

(22) PCT Filed: Sep. 30, 2016
(86) PCT No.: PCT/CN2016/101400

§ 371 Date: Jun. 22, 2017

(30) Foreign Application Priority Data
Dec. 9, 2015 (CN) 201510908147.5

(51) Int. Cl. G06F 17/30

(52) U.S. Cl. CPC G06F 17/30165; G06F 17/30091; G06F 17/30115

(57) ABSTRACT

The present disclosure provides a Samba configuration management method and system, and includes: when setting a share directory, adding information of the share directory into a configuration file of a Samba server, and storing the information of the share directory into a share backup file of the storage device; when it is detected that the storage device is removed from a network device, deleting the information of the share directory; and when it is detected that the storage device is inserted into the network device, reading piece by piece the share directory information in the share backup file, and acquiring a share path of the information of the share directory, modifying a disk letter of the share path into a current disk letter of the storage device, judging whether the modified share path exists, and if yes adding the information of the share directory into the configuration file.

The present application is an US national stage application of the international patent application PCT/CN2016/101400 filed on Sep. 30, 2016, which is based upon and claims the priority of Chinese Patent Application No. 201510908147.5 filed on Dec. 9, 2015 and entitled “SAMBA CONFIGURATION MANAGEMENT METHOD AND SYSTEM FOR NETWORK DEVICE”, the entire contents of which are incorporated herein by reference.

### TECHNICAL FIELD

The present disclosure relates to computer technologies, and in particular, to a samba configuration management method and system for a network device.

### BACKGROUND

A router typically provides a Samba service, which may share files stored in the router. A user may set file sharing by modifying the configuration file of Samba. The configuration information includes users who are allowed to access, share directories, read-write permissions and the like. The general practice for setting a share directory is adding information of a share directory into the configuration file of Samba, and the general practice for deleting a share directory is deleting the corresponding information of the share directory from the configuration file of Samba. In practice, since most external storage devices (for example, a U disk, a TF card and the like.) may be frequently inserted or removed. As a result, the share directory path of the Samba configuration file is inconsistent with the actual path thereof, and thus the user fails to access the configuration file. For example, a U disk 1 with a disk letter F is externally connected to a router initially, and if the F disk is shared, the share directory of the configuration file is the F disk; if subsequently the U disk 1 is removed and another U disk 2 is inserted, the disk letter of the U disk 2 is changed to F, and in this case if the U disk 1 is re-inserted, the disk letter of the U disk 1 is changed to G. However, the disk letter of the share directory recorded in the configuration file is still F disk, which causes a lot of invalid configurations in the Samba configuration file.

Accordingly, how to find a technical solution to reduce invalid configurations of router Samba configurations has indeed become a problem to be urgently solved by a person skilled in the art.

### SUMMARY

In view of the above defect in the prior art, the present disclosure is intended to provide a Samba configuration management method and system for a network device, to solve the problem in the prior art that invalid configurations are present in the Samba configuration file due to insertion or removal of an external storage device. To achieve the above objectives and other relevant objectives, the present disclosure provides a Samba configuration management method for a network device. The method includes: when setting a share directory in a storage device, adding information of the share directory into a configuration file of a Samba server, and storing the information of the share directory into a share backup file of the storage device, wherein the information of the share directory includes a share path; when it is detected that the storage device is removed from a network device, deleting the information of the share directory related to the storage device from the configuration file of the Samba server; and when it is detected that the storage device is inserted into the network device, reading piece by piece the information of the share directory in the share backup file of the storage device, and performing the following operations: acquiring a share path of the information of the share directory, modifying a disk letter of the share path into a current disk letter of the storage device, judging whether the modified share path exists, if the modified share path exists, adding the information of the share directory into the configuration file of the Samba server, and if the modified share path does not exist, deleting the information of the share directory from the share backup file.

Optionally, the share backup file is stored in a root directory of the storage device.

Optionally, the method further includes: when deleting a share directory of the storage device, deleting the information of the share directory from the configuration file of the Samba server, and deleting the information of the share directory from the share backup file of the storage device.

Optionally, the method further includes: when modifying a share directory of the storage device, modifying the information of the share directory in the configuration file of the Samba server, and modifying the information of the share directory in the share backup file of the storage device.

Optionally, the network device includes a router. The present disclosure further provides a Samba configuration management system for a network device. The system includes: a share information management module, configured to, when setting a share directory in a storage device, add information of the share directory into a configuration file of a Samba server, and store the information of the share directory into a share backup file of the storage device, wherein the information of the share directory includes a share path; a device removal management module, configured to, when it is detected that the storage device is removed from a network device, delete the information of the share directory related to the storage device from the configuration file of the Samba server; a device insertion management module, configured to, when it is detected that the storage device is inserted into the network device, read piece by piece the information of the share directory in the share backup file of the storage device, and perform the following operations: acquiring a share path of the information of the share directory, modifying a disk letter of the share path into a current disk letter of the storage device, judging whether the modified share path exists, if the modified share path exists, adding the information of the share directory into the configuration file of the Samba server, and if the modified share path does not exist, deleting the information of the share directory from the share backup file. Optionally, the share backup file is stored in a root directory of the storage device.

Optionally, the share backup file is a hidden file. Optionally, the share information management module is further configured to, when deleting a share directory of the storage device, delete the information of the share directory from the configuration file of the Samba server, and delete the information of the share directory from the share backup file of the storage device.

Optionally, the share information management module is further configured to, when modifying a share directory of the storage device, modify the information of the share directory in the configuration file of the Samba server, and modify the information of the share directory in the share backup file of the storage device.

Optionally, the network device includes a router.

As described above, the Samba configuration management method and system for a network device according to the present disclosure achieve the following benefits: Configuration information is backed up in a storage device, and the configuration information is imported to a Samba configuration file after the storage device is re-inserted into a router, such that the problem of share failure due to changes of the path of an external device is solved.

### BRIEF DESCRIPTION OF THE DRAWINGS

FIG. 1 is a schematic flowchart of a Samba configuration management method for a network device according to an embodiment of the present disclosure; and

FIG. 2 is a schematic diagram illustrating modules of a Samba configuration management system for a network device according to an embodiment of the present disclosure.

### REFERENCE NUMERALS AND DENOTATIONS THEREOF

1 Samba configuration management system for a network device
11 Share information management module
12 Device removal management module
13 Device insertion management module
S1-S3 Steps

### DETAILED DESCRIPTION

The embodiments of the present disclosure are described hereinafter with reference to specific examples. A person skilled in the art would readily understand and know the other advantages and technical effects of the present disclosure based on the content disclosed in the specification of the present disclosure. The present disclosure may also be implemented or applied with reference to other different specific embodiments. Various details in the specification may also be based on different viewpoints and applications, and various modifications or variations may be made without departing from the spirit of the present disclosure.

It should be noted that the drawings in the embodiments are merely intended to illustratively explain the basic concept of the present disclosure, and the drawings only illustrate components relevant to the present disclosure and are not drawn according to the quantity of components, the shapes and dimensions thereof in practice. The shape, quantity and scale of the components in practical implementation may be randomly altered, and the deployment of the components may be even more complicated.

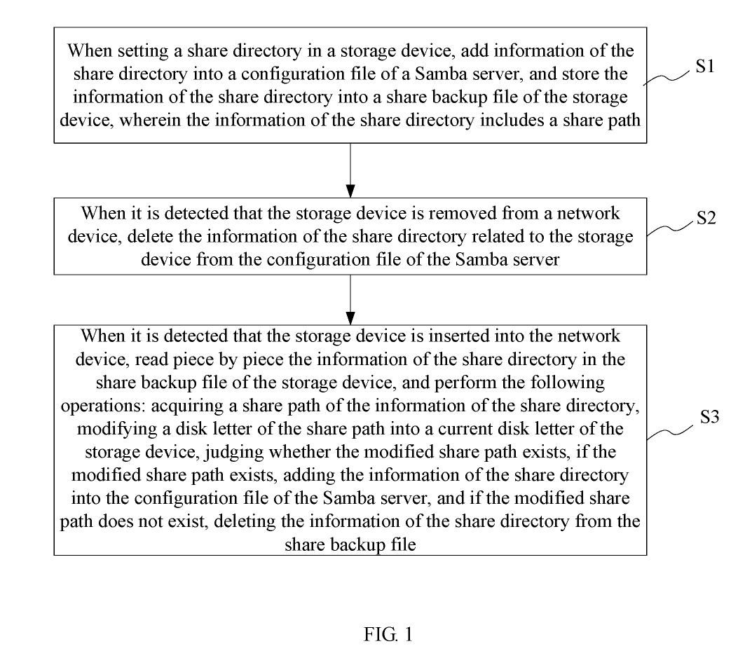

One embodiment of present disclosure further provides a Samba configuration management method for a network device. Samba is a toolkit, and implements Session Message Block protocol in Unix, which may be also referred to as the NETBIOS/LanManager protocol. Server Messages Block is a communication protocol for sharing files and printers over a local network, and provides services for sharing such resources as files and printers among different computers within the local area network. File sharing may be set by modifying the configuration file of Samba. The configuration information may include users who are allowed to access, share directories, read-write permissions and the like. The general practice for setting a share directory is adding information of the share directory into the configuration file of Samba (smb.conf), and the general practice for deleting a share directory is deleting the corresponding information of the share directory from the configuration file of Samba. In the technical solution, according to the present disclosure, the configuration information is imported to a Samba configuration file after the storage device is reinserted into a router, such that the problem of share failure due to changes of the path of an external device is solved. The network device includes a router. In one embodiment, as illustrated in FIG. 1, the Samba configuration management method includes the following steps: Step S1: When setting a share directory in a storage device, information of the share directory is added into a configuration file of a Samba server, and the information of the share directory is stored into a share backup file of the storage device, wherein the information of the share directory includes a share path. The information of the share directory refers to relevant information of the share directory, and may include a share path, a share name, users who are allowed to access, read-write permissions and the like. In one embodiment, the share backup file may be stored in a root directory of the storage device. The share backup file is a hidden file. The storage device is an external storage device, including a U disk, a TF card and the like.

Step S2: When it is detected that the storage device is removed from a network device, the information of the share directory related to the storage device is deleted from the configuration file of the Samba server. The network device includes a router.

Step S3: When it is detected that the storage device is inserted into the network device, the information of the share directory in the share backup file of the storage device is read piece by piece, and the following operations are performed: acquiring a share path of the information of the share directory, modifying a disk letter of the share path into a current disk letter of the storage device, judging whether the modified share path exists, if the modified share path exists, adding the information of the share directory into the configuration file of the Samba server, and if the modified share path does not exist, deleting the information of the share directory from the share backup file. In one embodiment, the method further includes: when deleting a share directory of the storage device, deleting the information of the share directory from the configuration file of the Samba server, and deleting the information of the share directory from the share backup file of the storage device. In one embodiment, the method further includes: when modifying a share directory of the storage device, modifying the information of the share directory in the configuration file of the Samba server, and modifying the information of the share directory in the share backup file of the storage device. In practice application, steps S1, S2 and S3 according to the present disclosure may be randomly performed without any sequential restriction as described above.

In one embodiment, the network device is a router. A Samba configuration management method for this network device includes: 1. Setting a share directory: When the router shares a file of a network, the configuration file smb.conf of a Samba server may be modified, and share-relevant information (for example, a share path, a share name, users who are allowed to access, read-write permission and the like) is backed up under a root directory of the device, wherein the backup file is a hidden file. When the share file is deleted or modified, the backup file in the root directory is also modified. 2. Inserting or removing an external storage device: A. When a storage device is inserted, the CPU judges whether a backup of the Samba configuration file exists in the storage device, and if the backup exists, the backup information is read, and whether the disk letter in the share path is the current disk letter is judged, if the backup does not exist, the disk letter is modified to the current disk letter, then whether the share path exists is judged, if the share path does not exist, the share information is deleted, and otherwise, the share information is added to the configuration file smb.conf of the Samba server. B. When a storage device is removed, the CPU detects that the storage device is removed, and then clears all share information relevant to the storage device.

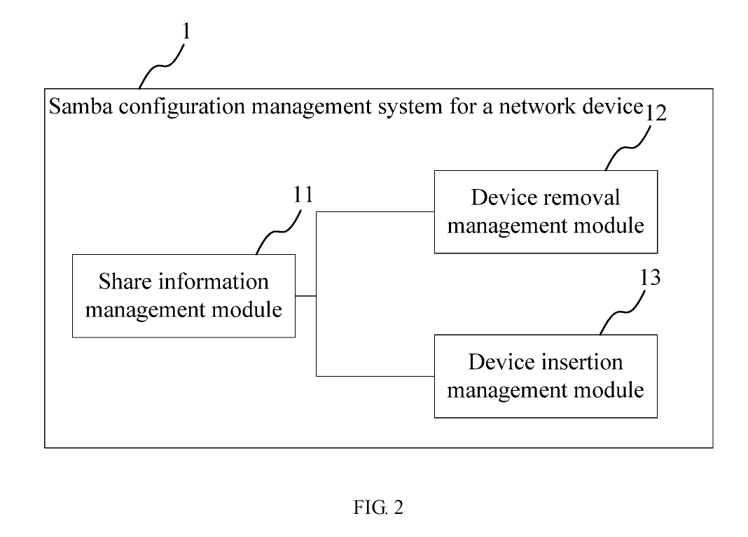

The embodiment of present disclosure further provides a Samba configuration management system for a network device. The above described Samba configuration management method may be applied in the Samba configuration management system. The network device includes a router. In one embodiment, as illustrated in FIG. 2, a Samba configuration management system 1 for a network device includes a share information management module 11, a device removal management module 12 and a device insertion management module 13.

The share information management module 11 is configured to, when setting a share directory in a storage device, add information of the share directory into a configuration file of a Samba server, and store the information of the share directory into a share backup file of the storage device, wherein the information of the share directory includes a share path. The information of the share directory refers to relevant information of the share directory, and may include a share path, a share name, users who are allowed to access, read-write permissions and the like. In one embodiment, the share backup file may be stored in a root directory of the storage device. The share backup file is a hidden file. In one embodiment, the share information management module 11 is further configured to, when deleting a share directory of the storage device, delete the information of the share directory from the configuration file of the Samba server, and delete the information of the share directory from the share backup file of the storage device. In one embodiment, the share information management module 11 is further configured to, when modifying a share directory of the storage device, modify the information of the share directory in the configuration file of the Samba server, and modify information of the share directory in the share backup file of the storage device. The storage device is an external storage device, including a U disk, a TF card and the like.

The device removal management module is connected to the share information management module 11, and configured to, when it is detected that the storage device is removed from a network device, delete information of the share directory related to the storage device from the configuration file of the Samba server. The network device includes a router. The device insertion management module 13 is connected to the share information management module 11, and configured to, when it is detected that the storage device is inserted into the network device, read piece by piece the information of the share directory in the share backup file of the storage device, and perform the following operations: acquiring a share path of the information of the share directory, modifying a disk letter of the share path into a current disk letter of the storage device, judging whether the modified share path exists, if the modified share path exists, adding the information of the share directory into the configuration file of the Samba server, and if the modified share path does not exist, deleting information of the share directory from the share backup file.

As described above, in the Samba configuration management method and system for a network device according to the present disclosure, configuration information is backed up in a storage device, and the configuration information is imported to a Samba configuration file after the storage device is reinserted into a router, such that the problem of share failure due to changes of the path of an external device is solved. Therefore, the present disclosure effectively overcomes various defects in the prior art and has high industrial value.

The above embodiments are merely used for exemplarily illustrate the principles, functions and effects of the present disclosure, but are not intended to limiting the present disclosure. Any person skilled in the art would make polishments or modifications to the above embodiments without departing from the spirit and category of the present disclosure. Therefore, any equivalent polishments or modifications derived a person having common knowledge in the art without departing from the spirit and inventive concept of the present disclosure shall all be covered within the scope defined by the claims of the present disclosure.

What is claimed is:

1. A Samba configuration management method for a network device, comprising:
when setting a share directory in a storage device, adding information of the share directory into a configuration file of a Samba server, and storing the information of the share directory into a share backup file of the storage device, wherein the information of the share directory comprises a share path;
when it is detected that the storage device is removed from a network device, deleting the information of the share directory related to the storage device from the configuration file of the Samba server; and
when it is detected that the storage device is inserted into the network device, reading piece by piece, the information of the share directory in the share backup file of the storage device, and performing the following operations:
acquiring a share path of the information of the share directory;
modifying a disk letter of the share path into a current disk letter of the storage devices;
judging whether the modified share path exists;
if the modified share path exists, adding the information of the share directory into the configuration file of the Samba server; or
if the modified share path does not exist, deleting the information of the share directory from the share backup file.

2. The Samba configuration management method for a network device according to claim 1, further comprising when deleting a share directory of the storage device, deleting the information of the share directory from the configuration file of the Samba server, and deleting the information of the share directory from the share backup file of the storage device.

3. The Samba configuration management method for a network device according to claim 1, further comprising when modifying a share directory of the storage device, modifying the information of the share directory in the configuration file of the Samba server, and modifying the information of the share directory in the share backup file of the storage device.

4. The Samba configuration management method for a network device according to claim 1, wherein the network device comprises a router.

5. A Samba configuration management system for a network device, comprising:
a share information management module, configured to, when setting a share directory in a storage device, add information of the share directory into a configuration file of a Samba server, and store the information of the share directory into a share backup file of the storage device, wherein the information of the share directory comprises a share path;
a device removal management module, configured to, when it is detected that the storage device is removed from a network device, delete the information of the share directory related to the storage device from the configuration file of the Samba server;
a device insertion management module, configured to, when it is detected that the storage device is inserted into the network device, read, piece by piece, the information of the share directory in the share backup file of the storage device, and perform the following operations:
acquiring a share path of the information of the share directory;
modifying a disk letter of the share path into a current disk letter of the storage devices;
judging whether the modified share path exists;
if the modified share path exists, adding the information of the share directory into the configuration file of the Samba server; or
if the modified share path does not exist, deleting the information of the share directory from the share backup file.

6. The Samba configuration management system for a network device according to claim 5, wherein the share information management module is further configured to, when deleting a share directory of the storage device, delete the information of the share directory from the configuration file of the Samba server, and delete the information of the share directory from the share backup file of the storage device.

7. The Samba configuration management system for a network device according to claim 5, wherein the share information management module is further configured to, when modifying a share directory of the storage device, modify the information of the share directory in the configuration file of the Samba server, and modify the information of the share directory in the share backup file of the storage device.

8. The Samba configuration management system for a network device according to claim 5, wherein the share backup file is stored in a root directory of the storage device.

9. The Samba configuration management system for a network device according to claim 5, wherein the share backup file is a hidden file.

10. The Samba configuration management system for a network device according to claim 5, wherein the network device comprises a router.
